(19) United States
(12) Patent Application Publication
(10) Pub. No.: US 2008/0284180 A1
(43) Pub. Date: Nov. 20, 2008

(54) Child Safety Gate Assemblies

(75) Inventor: Vaughan Stephen Newcombe, Hampshire (GB)

Correspondence Address: LOWE HAUPTMAN HAM & BERNER, LLP, 1700 DIAGONAL ROAD, SUITE 300, ALEXANDRIA, VA, 22314, US

(73) Assignee: BETTACARE LIMITED, Surrey (GB)

(21) Appl. No.: 12/091,975

(22) PCT Filed: Nov. 15, 2006
(86) PCT No.: PCT/GB2006/004267

§ 371 Date: Jul. 9, 2008

(30) Foreign Application Priority Data
Nov. 30, 2005 (GB) 0524416.5

(51) Int. Cl. E06B 9/04; E05C 3/12

(52) U.S. Cl. 292/198

(57) ABSTRACT

A child safety gate assembly for fitting across a staircase, passageway or the like includes a frame having at least one upstanding limb, pivotally connected to which is a gate carrying a latch assembly. The latch assembly is pivotally mounted on the gate and includes a latch member, a release member and an actuating member. The latch member is pivotally mounted on the gate and includes a movable latching portion. The latch member is movable, when the gate is closed, between a latched position, in which the movable latching portion is in engagement with a stationary latching portion and pivotal movement of the gate is prevented, and an unlatched position, in which the movable and stationary latching portions are not in engagement and pivotal movement of the gate is permitted. The release member cooperates with the latch member and is manually movable between a locked position, in which it prevents movement of the latch member out of the latched position, and an unlocked position, in which it permits movement of the latch member. The actuating member is connected to the latch member and is manually movable, when the release member is in the unlocked position, from a rest position to an operative position so as thereby to move the latch member from the latched position to the unlatched position.

### RELATED APPLICATIONS

The present application is based on International Application Number PCT/GB2006/004267 filed Nov. 15, 2006, and claims priority from British Application Number 0524416.5 filed Nov. 30, 2005, the disclosures of which are hereby incorporated by reference herein in their entirety.

### FIELD OF THE INVENTION

The present invention relates to child safety gate assemblies, that is to say assemblies of the type which may be selectively positioned in a passageway, doorway or the like in order to prevent access by children. Such gate assemblies typically comprise a U-shaped frame, though the frame may also be of L shape, whose upper portion is open and which defines an aperture in which a gate is received, pivotally connected to an upstanding limb of the frame. The gate may be latched in the closed position to a stationary latch portion which may be connected to the adjacent wall or the like but is more usually connected to the other upstanding limb of the U-shaped frame. The latch mechanism is typically of childproof type, that is to say it may readily be opened by an adult but young children are generally insufficiently strong or coordinated to be able to open it.

In practice, it is often found that so-called childproof latches can sometimes be opened by children or that if they are truly childproof it can be quite difficult for even an adult to open it. It is, therefore, the object of the invention to provide a child safety gate assembly with a childproof latch which is truly childproof, at least to very young children, but may nevertheless be readily opened by an adult.

### SUMMARY OF THE INVENTION

According to the present invention, there is provided a child safety gate assembly for fitting across a staircase, passageway or the like including a frame having at least one upstanding limb, pivotally connected to which is a gate carrying a latch assembly, the latch assembly including a latch member, a release member and an actuating member, the latch member being pivotally mounted on the gate and including a movable latching portion, the latch member being movable, when the gate is closed, between a latched position, in which the movable latching portion is in engagement with a stationary latching portion and pivotal movement of the gate is prevented, and an unlatched position, in which the movable and stationary latching portions are not in engagement and pivotal movement of the gate is permitted, the release member cooperating with the latch member and being manually movable between a locked position, in which it prevents movement of the latch member out of the latched position, and an unlocked position in which it permits movement of the latch member, the actuating member being connected to the latch member and being manually movable, when the release member is in the unlocked position, from a rest position to an operative position so as thereby to move the latch member from the latched position to the unlatched position.

Thus the safety gate assembly in accordance with the invention includes a latch member, which is arranged selectively to latch the gate in the closed position and is connected to an actuating member and thus moves together with the actuating member. Manual actuation of the actuating member will thus result in movement of the latch member from the latched position to the unlatched position. The latch assembly also includes a release member which cooperates with the latch member and is manually movable between a locked position, in which the latch member is unable to move out of the latched position, and an unlocked position in which movement of the latch member is permitted. Thus when the release member is in the locked position, the latch member is unable to move and thus the application of force to the actuating member does not result in movement of the latch member. It is therefore necessary for two hands to be used simultaneously to open the gate, one hand being used to move the release member to the unlocked position and the other hand being used to apply a force to the actuating member which results in movement of the latch member from the latched to the unlatched position. Whilst an adult is readily capable of performing these two different actions with two hands, children generally lack the necessary strength and coordination to be able to do so and the gate assembly is therefore effectively childproof.

The movable latching portion must of course cooperate with some stationary latching portion, when the gate is latched, in order to retain the gate in the closed position. The frame may be of generally L shape with one upstanding limb to which the gate is pivotally connected and in this case the stationary latching portion will need to be connected to an adjacent wall or the like. It is, however, preferred that the frame is of generally U-shape with two upstanding limbs and in this event the stationary latching portion will be connected to or constitute part of that upstanding limb to which the gate is not pivotally connected.

In practice, the release member and the actuating member will carry respective locking formations which cooperate, when the release member is in the locked position, to prevent movement of the latch member out of the latched position. It is preferred that these locking formations are so arranged that they will also prevent movement of the latch member out of the unlatched position. This will mean that the latch member will have two discrete positions in which it may be latched and from which it may therefore not readily be moved without operation of the release member.

The release member can be moved from the locked position to the unlocked position and vice versa by the application of manual pressure but it is preferred that it is associated with first biasing means which are arranged to bias it into the locked position. It is therefore necessary to move it manually into the unlocked position but it is moved in the opposite direction by the biasing means, such as a compression spring. Similar considerations apply also to the actuating member and it is preferred that second biasing means, such as a further compression spring, are associated with the actuating member and bias it into the rest position.

The actuating member and the latch member may be arranged to move linearly but it is preferred that they are pivotally connected to the gate by respective pivotal connections. It is preferred that the connection of the actuating member and the latch member is effected by an actuating projection carried by one of them which is slidably received in an elongate aperture formed in the other of them. It will be appreciated that it is necessary for this aperture to be elongate if the actuating member and latch member are connected to the gate by respective pivotal connections because pivotal movement will necessarily result in a certain amount of linear movement at the connection point and the combination of a peg or the like in an elongate aperture will permit this relative linear movement to occur whilst nevertheless resulting in a connection of the actuating member and the latch member such that the two members can only move in unison and cannot move relative to one another. It is, however, preferred that the release member is mounted for linear movement under the application of manual pressure.

### BRIEF DESCRIPTION OF THE DRAWINGS

Further features and details of the invention will be apparent from the following description of one specific embodiment of child safety gate assembly in accordance with the invention which is given by way of example only with reference to the accompanying drawings, in which:

FIG. 1 is a perspective view of the gate assembly;

FIG. 2 is a scrap partly cut-away view of the latch portion of the assembly with the latch in the latched position;

FIG. 3 is a view similar to FIG. 2 showing the latch in the released position; and

FIG. 4 is a further view similar to FIG. 2 showing the latch in the unlatched position.

### DETAILED DESCRIPTION OF THE EMBODIMENTS

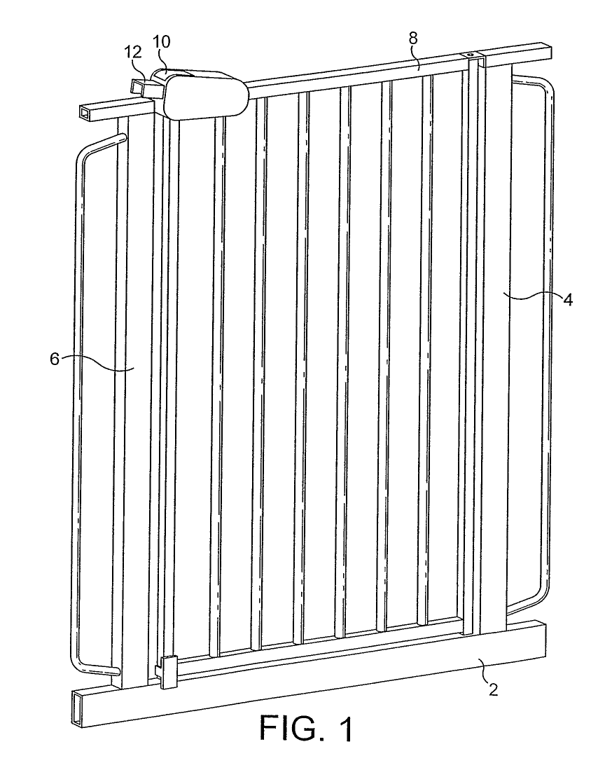

Referring firstly to FIG. 1, it will be seen that the gate assembly comprises a U-shaped frame, pivotally connected to one upstanding limb of which is a gate. In use, the assembly will be secured in position across a passageway, doorway or staircase by any one of a number of mechanisms, which are well known per se. Typically, a threaded bolt is received in a threaded hole at each end of the base and at the top of the upstanding limbs. Each bolt is rotated until a stop member on its free end is forced into contact with an adjacent wall and the assembly is thus fixed in position. The frame comprises a base 2 and two spacing upstanding limbs 4 and 6, which together define a substantially rectangular aperture. Pivotally connected to the limb 4 is one side of a rectangular gate 8 whose size generally matches that of the aperture. The gate may thus be manually pivoted between a closed position, as shown in the drawing, in which the aperture is closed, and an open position in which a child or adult may walk over the base 2 and through the aperture. Secured at the top of the free side edge of the gate 8 is a childproof latch assembly 10. This includes a movable latching member 12 which is movable between the unlatched position shown in FIG. 1, in which pivotal movement of the gate is permitted, and a latched position in which it cooperates with a portion of the upstanding limb 8 and prevents pivotal movement of the gate.

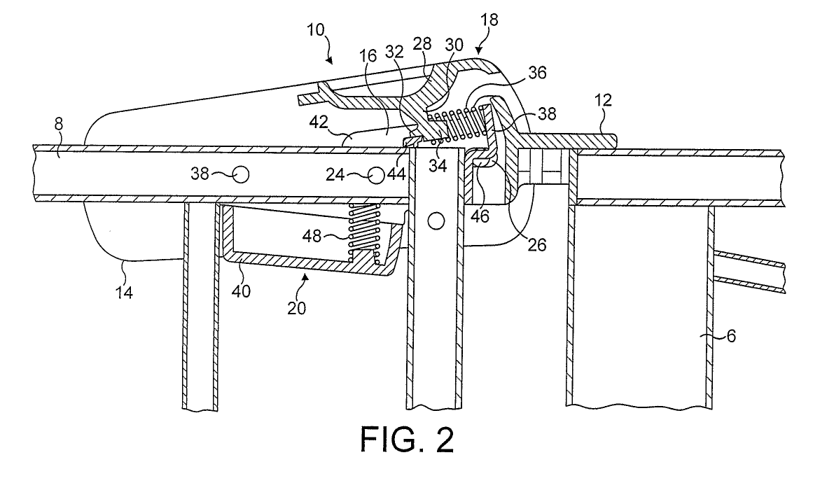

Turning now to FIGS. 2 to 4, the latch assembly comprises an outer housing 14, a latch member 16, a release member 18 and an actuating member 20.

The latch member 16 is pivotally connected to the top of the gate 8 at 22. At its free end it has a movable latching portion 12 which extends out of the housing through an opening in the right-hand side of the housing, as seen in FIGS. 2 to 4. The movable latching portion is of inverted U-shaped channel section with the channel having a shape corresponding to that of the upper portion of the upstanding limb 6. At a position intermediate its ends it is provided with an elongate slot 26, the purpose of which will be described below.

The release member 18 comprises an upper concave portion 28, whose upper surface is visible and accessible in an opening in the upper surface of the housing 14. Integral with the concave portion is a depending portion 30, extending laterally from which is a locking projection 32, the purpose of which will be explained below. Extending laterally in the opposite direction from the depending portion 30 is a further projection 34, which extends into one end of a compression spring 36. The other end of the spring 36 engages on a bracket 38 connected to the top of the gate. The spring 36 thus acts on the release member and tends to urge it, that is to say to bias it, to the left, as seen in FIGS. 2 to 4. This will be discussed in more detail below.

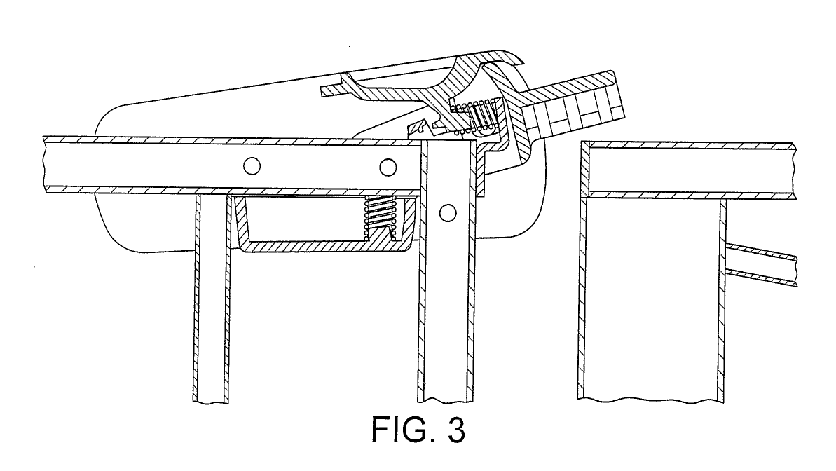

The actuating member 20 is pivotally connected to the top of the gate by means of a pivot pin 38. The actuating member includes a handle portion 40 and an actuating portion 42. The actuating portion 42 is generally flat and extends in a plane parallel to that of the gate. Projecting laterally from it is a locking projection 44 which cooperates with the locking projection 32. Also projecting laterally from it is an actuating projection 46 which is slidably received in the elongate aperture 26. The actuating member 20 is movable by the application of manual pressure to the handle portion 40 from the rest position shown in FIG. 2 to an operative position shown in FIG. 3. A compression spring 48 acts between the top of the gate 8 and the handle portion 40 and biases it towards the rest position. When the actuating member is moved into the operative position, the actuating projection is moved upwardly and engages the upper edge of the aperture 26 and thus moves the latch member upwardly, thereby moving it from the latched position to the unlatched position. The latch member and actuating member both move in rotation but about different pivotal axes. The fact that the aperture 26 is elongate permits the relative linear movement that occurs at this point to be accommodated.

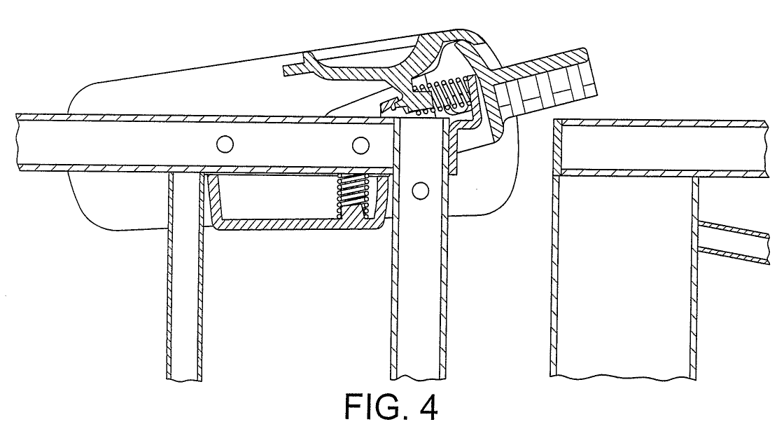

When the gate is closed and latched, the latch is in the position shown in FIG. 2. The movable latching portion 12 engages over and round the top of the limb 6, thereby preventing the gate from being opened. The application of manual upward pressure to the handle portion 40 will not result in movement of the actuating member because the upper surface of the locking projection 44 is in engagement with the lower surface of the locking projection 32, thereby preventing movement of the actuating member. The application of upward manual pressure directly to the latching portion will also not result in movement of the latching member because it is locked in position by the engagement of the actuating projection 46 in the aperture 26. The gate can thus not be readily opened by a child. However, if an adult wishes to open the gate, all that is necessary is to place the thumb in the recess in the upper surface of the release member and exert a pressure to the right, as seen in the Figures. This results in the release member sliding to the right against the force of the return spring 36. The release member thus moves out of the locked position shown in FIG. 2 into the released or unlocked position shown in FIG. 3. The locking projections 32 and 44 are now laterally spaced apart and if manual pressure is now applied to the handle portion 40, the actuating member will rotate anti-clockwise and the actuating projection 46 will move upwardly thereby lifting the latch member and moving it into the unlatched position. The gate can now readily be opened. If the release member is now released, it will be moved back to its previous position, that is to say the locked position, by the biasing force of the spring 36. However, the locking projection 32 will now be situated below the locking projection 44, as shown in FIG. 4, and movement of the latch member back towards the latched position under the action of the return spring 48 is thus prevented. The latch member is thus now locked in the unlatched position. It can of course readily be unlocked by the application of a lateral force to the right to the release member 18. Once the locking projections 32 and 48 are no longer opposite one another, the actuating member will return to its rest position and the cooperation of the actuating projection 46 with the aperture 26 will mean that as it does so the latch member will also return to the latched position.

1. A child safety gate assembly for fitting across a staircase, passageway or the like including a frame having at least one upstanding limb, pivotally connected to which is a gate carrying a latch assembly, the latch assembly including a latch member, a release member and an actuating member, the latch member being pivotally mounted on the gate and including a movable latching portion, the latch member being movable, when the gate is closed, between a latched position, in which the movable latching portion is in engagement with a stationary latching portion and pivotal movement of the gate is prevented, and an unlatched position, in which the movable and stationary latching portions are not in engagement and pivotal movement of the gate is permitted, the release member cooperating with the latch member and being manually movable between a locked position, in which it prevents movement of the latch member out of the latched position, and an unlocked position in which it permits movement of the latch member, the actuating member being connected to the latch member and being manually movable, when the release member is in the unlocked position, from a rest position to an operative position so as thereby to move the latch member from the latched position to the unlatched position.

2. An assembly as claimed in claim 1 in which the frame is of generally U shape with two upstanding limbs, the stationary latching portion being connected to or constituting part of that upstanding limb to which the gate is not pivotally connected.

3. An assembly as claimed in claim 1 in which the release member and the actuating member carry respective locking formations which cooperate, when the release member is in the locked position, to prevent movement of the latch member out of both the latched and unlatched positions.

4. An assembly as claimed in claim 1 including first biasing means cooperating with the release member and arranged to bias it into the locked position.

5. An assembly as claimed in claim 1 including second biasing means cooperating with the actuating member and arranged to bias it into the rest position.

6. An assembly as claimed in claim 1 in which the actuating member and the latch member are pivotally connected to the gate by respective pivotal connections, one of the actuating member and the latch member carrying an actuating projection which is slidably received in an elongate aperture formed in the other of the actuating member and the latch member.

7. An assembly as claimed in claim 1 in which the release member is mounted for linear movement under the application of manual pressure.
